(19) United States
(12) Patent Application Publication
(10) Pub. No.: US 2018/0279824 A1
(43) Pub. Date: Oct. 4, 2018

(54) Cookware Insulating Lid Cover

(71) Applicants: Sean Birmingham, Hilo, HI (US); Angelina Kawahashi, Hilo, HI (US); Miharu Birmingham, Hilo, HI (US)

(72) Inventors: Sean Birmingham, Hilo, HI (US); Angelina Kawahashi, Hilo, HI (US); Miharu Birmingham, Hilo, HI (US)

(21) Appl. No.: 15/935,270

(22) Filed: Mar. 26, 2018

Related U.S. Application Data
(60) Provisional application No. 62/477,743, filed on Mar. 28, 2017.

(51) Int. Cl. A47J 36/06; B65D 81/38

(52) U.S. Cl. CPC A47J 36/06; B65D 81/38

(57) ABSTRACT

A cookware insulating lid cover. The cookware insulating lid cover includes a panel having a flexible insulating material. A perimeter of the panel is dimensioned to align with a border of a lid of a piece of cookware, such that the panel can rest flush against the lid. A slit is disposed within the panel, wherein the slit can receive a grip of the lid therethrough.

### CROSS REFERENCE TO RELATED APPLICATIONS

This application claims the benefit of U.S. Provisional Application No. 62/477,743 filed on Mar. 28, 2017. The above identified patent application is herein incorporated by reference in its entirety to provide continuity of disclosure.

### BACKGROUND OF THE INVENTION

The present invention relates to cookware insulating lid covers. Specifically, the present invention relates to cookware insulating lid covers having a slit therein for receiving a grip of a lid of a piece of cookware therethrough, such that the cookware insulating lid cover is configured to rest flush against the lid.

Many people enjoy cooking at home, however cooking on a stovetop requires significant energy input, in the form of heat, which is generally provided by electricity or gas. Cooking implements, however, inefficiently make use of this energy, as heat is frequently dissipated from the cookware to the surrounding area, thereby requiring more energy to be input into the cookware to make up losses. Due to the relatively large surface area exposed to the surrounding area, a significant amount of the heat is lost through the lid and upper portion of the cookware. Maintaining a proper cooking temperature is often a difficult process as the heat must constantly be monitored and adjusted to make up for energy losses to the surrounding area. As energy is lost, additional time is required to thoroughly cook food, increasing user frustration. Therefore, an energy efficient method of retaining heat in cookware without using additional energy from an external source is desired.

In light of the devices disclosed in the known art, it is submitted that the present invention substantially diverges in design elements from the known art and consequently it is clear that there is a need in the art for an improvement to existing cookware insulating lid covers. In this regard, the instant invention substantially fulfills these needs.

### SUMMARY OF THE INVENTION

In view of the foregoing disadvantages inherent in the known types of cookware insulating lid covers now present in the prior art, the present invention provides a cookware insulating lid cover wherein the same can be utilized for providing convenience for the user when retaining heat within a piece of cookware.

The present system comprises a panel comprising a flexible insulating material, wherein a perimeter of the panel is dimensioned to align with a border of a lid of a piece of cookware. The panel is further configured to rest flush against the lid, wherein a grip of the lid is configured to extend through a slit disposed through a panel, such that the user can still grip the lid when the lid cover is applied. In some embodiments, an inner perimeter of the slit comprises an elastic material configured to removably secure the slit about the grip. In other embodiments, the panel comprises an upper layer, a lower layer, and an interior layer therebetween. In yet another embodiment, the lower layer comprises a heat reflective surface, wherein the heat reflective surface is configured to reflect heat towards the lid. In some embodiments, the interior layer comprises an insulating material configured to inhibit heat transfer through the panel. In another embodiment, the interior layer comprises a padded material. In other embodiments, the panel further comprises a loop disposed on the perimeter of the panel, wherein the loop is configured to receive a handle of the piece of cookware therethrough.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the cookware insulating lid cover.

FIG. 2 shows an exploded view of an embodiment of the cookware insulating lid cover and cookware.

FIG. 3 shows a cross-sectional view of an embodiment of the cookware insulating lid cover.

### DETAILED DESCRIPTION OF THE INVENTION

Reference is made herein to the attached drawings. Like reference numerals are used throughout the drawings to depict like or similar elements of the cookware insulating lid cover. The figures are intended for representative purposes only and should not be considered to be limiting in any respect.

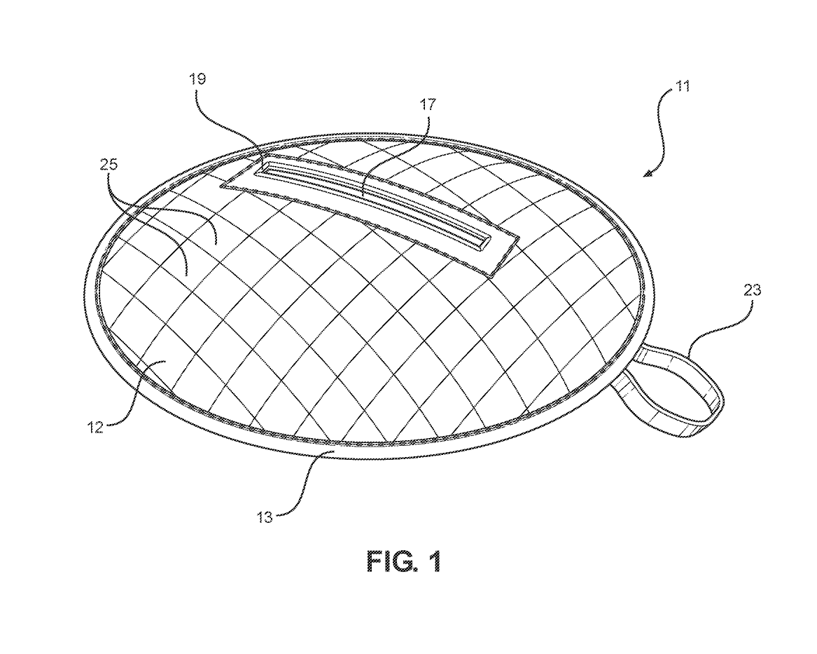

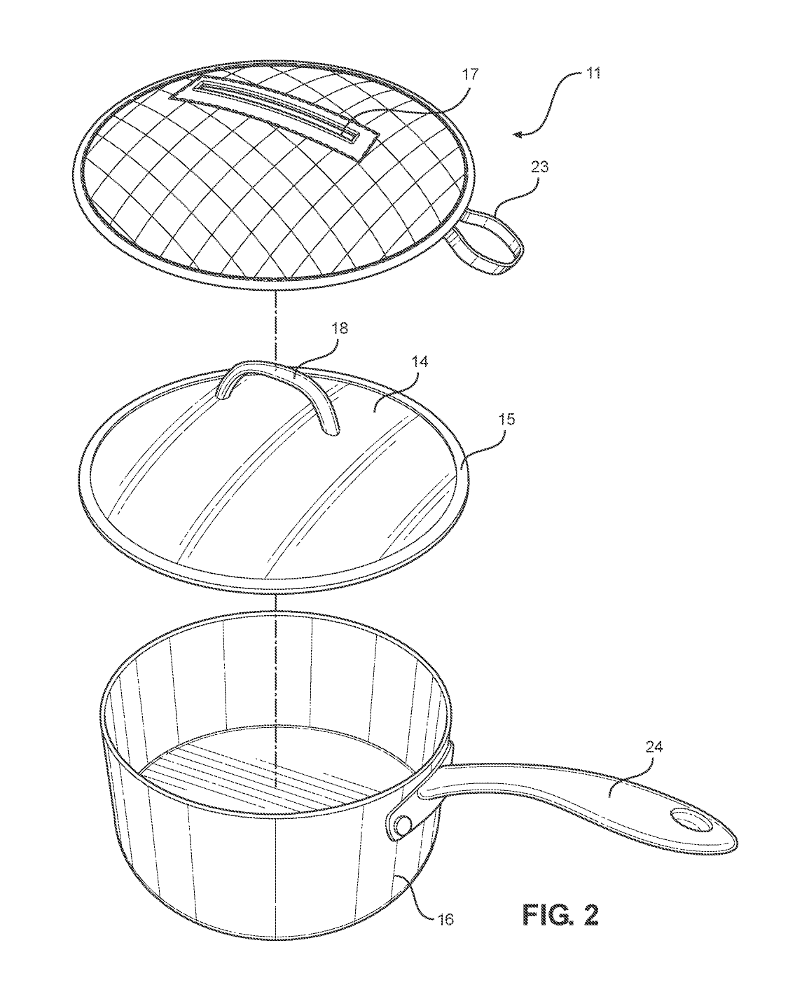

Referring now to FIGS. 1 and 2, there is shown a perspective view of an embodiment of the cookware insulating lid cover and an exploded view of an embodiment of the cookware insulating lid cover and cookware, respectively. The cookware insulating lid cover 11 comprises a panel 12 dimensioned to cover a lid 14 of a piece of cookware 16. In the illustrated embodiment, the panel 12 comprises a round cross-section, however alternate cross-sections are contemplated to fit a variety of different lids 14. Further, the in the shown embodiment, the panel 12 comprises a quilted pattern, wherein the quilted pattern forms a plurality of pockets 25 within the panel 12, wherein the pockets 25 are configured to hold an insulating material therein. The panel 12 is configured to be flexible, such that the panel 12 rests flush against an upper surface of the lid 14. This ensures that the maximum surface area of the lid 14 is insulated by the cookware insulating lid cover 11, while minimizing air pockets or other occurrences that would limit the efficiency of insulation. The panel 12 is further composed of an insulated material, such that heat transfer therethrough is inhibited, thereby trapping heat beneath the panel 12 and within the piece of cookware 16. The insulating material can comprise any known in the art to slow the transfer of heat, such as, but not limited to, wool, cotton flannel, and the like.

The panel 12 further comprises a slit 17 disposed therethrough, wherein the slit 17 is configured to receive a grip 18 of the lid 14 therethrough. In this way, the grip 18 does not prevent the panel 12 from resting flush against the lid 14 to ensure maximum insulation efficiency. Additionally, the slit 17 allows the user to interact with the grip 18 without requiring the user to remove the panel 12 from the lid 14. In this way, the user is provided convenience when cooking, allowing the user to intermittently check the food within the cookware 16 without needing to remove the panel 12. In the illustrated embodiment, the slit 17 comprises a linear opening along a central portion of the pane 12, wherein the slit 17 is configured to receive an arcuate grip 18 therethrough. In alternate embodiments, the slit 17 comprises a cross-sectional shape configured to conform to various grip 18 cross-sections.

The panel 12 is further dimensioned such that a perimeter 13 of the panel 12 is configured to align with a border 15 of the lid 14 when the panel 12 is placed upon the lid 14. In this way, the entirety of the lid 14 is covered, thereby insulating the maximum area. In some embodiments, an inner perimeter 19 of the slit 17 comprises an elastic material, wherein the elastic material is configured to removably secure the slit 17 about the grip 18. In this way, the user is ensured that the panel 12 does not ride up the grip 18 during use, thereby maintaining contact with the lid 14 at all times.

In the illustrated embodiment, the cookware insulating lid cover 11 further comprises a loop 23 disposed along the perimeter 13 of the panel 12. The loop 23 is configured to secure about a handle 24 of the piece of cookware 16, such that the panel 12 is prevented from rotating about the lid 14. Additionally, the loop 23 can be used to store the cookware insulating lid cover 11 in a hanging position, thereby occupying less space and providing convenience in storage for the user. In some embodiments, the loop 23 comprises an elastic material, such that the loop 23 is removably securable to the handle 24.

In one exemplary use, the user selects the desired piece of cookware 16 for a cooking application, and then retrieves a cookware insulating lid cover 11 dimensioned to fit the lid 14 of the selected cookware 16. The panel 12 is then placed flush against the lid 14, such that the perimeter 13 is aligned with the border 15. The grip 18 is then inserted through the slit 17 such that the grip 18 extends therethrough. In some embodiments, the inner perimeter 19 secures the slit 17 to the grip 18, such that the panel 12 is secure about the lid 14 and the grip 18. Should the user need to check the food being cooked in the piece of cookware 16, the user can grasp the grip 18 and remove the lid 14 without removing the panel 12 from the lid 14. In an alternate embodiment, the lid cover 11 is further secured to the lid 14 by inserting the handle 24 of the cookware 16 through the look 23.

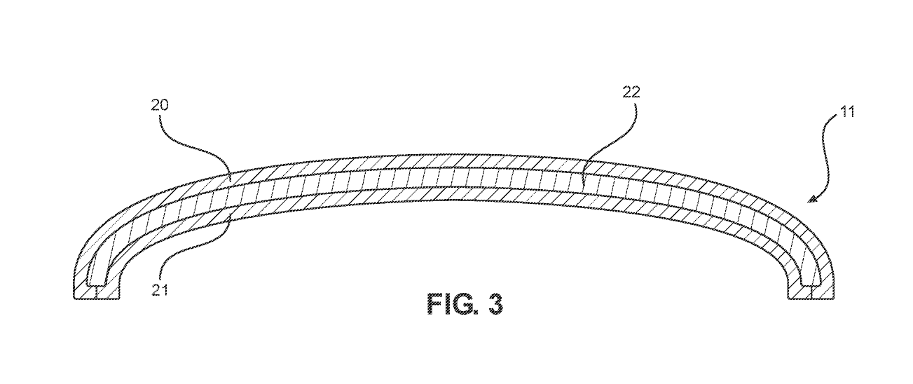

Referring now to FIG. 3, there is shown a cross-sectional view of an embodiment of the cookware insulating lid cover. In the illustrated embodiment, the lid cover 11 comprises an upper layer 20, a lower layer 21, and an interior layer 22 therebetween. In the illustrated embodiment, the lower layer 21 is concave, thereby allowing the lid cover 11 to rest flush against the upper surface of the lid. In some embodiments, the interior layer 22 comprises an insulating filling material configured to prevent heat transfer therethrough, such as polyethylene foam, cellulose, polystyrene, fiberglass, or the like. The interior layer 22 can further comprise a padded material, such that the user can comfortably interact with the lid cover 11 when in use, while also preventing direct contact with the rigid surface of the lid. In another embodiment, the lower layer 21 comprises a heat reflective coating thereon, such that heat directed towards the lower layer 21 is redirected towards the lid and the cookware, thereby further preventing heat loss from the cookware.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A cookware insulating lid cover, comprising:
a panel comprising a flexible insulating material;
a perimeter of the panel dimensioned to align with a border of a lid of a piece of cookware;
wherein the panel is configured to rest flush against the lid;
a slit disposed in the panel, wherein the slit is configured to receive a grip of the lid therethrough.

2) The cookware insulating lid cover of claim 1, wherein an inner perimeter of the slit comprises an elastic material configured to removably secure the slit about the grip.

3) The cookware insulating lid cover of claim 1, wherein the panel comprises an upper layer, a lower layer, and an interior layer therebetween.

4) The cookware insulating lid cover of claim 4, wherein the lower layer comprises a heat reflective surface, wherein the heat reflective surface is configured to redirect heat towards the lid.

5) The cookware insulating lid cover of claim 4, wherein the interior layer comprises insulation configured to inhibit heat transfer through the panel.

6) The cookware insulating lid cover of claim 4, wherein the interior layer comprises a padded material.

7) The cookware insulating lid cover of claim 1, wherein a loop is disposed on the perimeter of the panel, the loop configured to receive a handle of the piece of cookware therethrough.

8) The cookware insulating lid cover of claim 1, wherein a plurality of pockets are disposed within the panel, wherein each of the plurality of pockets are configured to receive a heat insulating material therein.
